(19) United States
(12) Patent Application Publication
(10) Pub. No.: US 2009/0156309 A1
(43) Pub. Date: Jun. 18, 2009

(54) HANDWEAR DEVICES AND METHODS FOR PROVIDING AN INTERACTIVE PLAY EXPERIENCE

(75) Inventors: Denise Chapman Weston, Wakefield, RI (US); Rick A. Briggs, Springfield, IL (US)

Correspondence Address: KNOBBE MARTENS OLSON & BEAR LLP, 2040 MAIN STREET, FOURTEENTH FLOOR, IRVINE, CA, 92614, US

(73) Assignee: Creative Kingdoms, LLC, Springfield, IL (US)

(21) Appl. No.: 12/237,815

(22) Filed: Sep. 25, 2008

Related U.S. Application Data
(60) Provisional application No. 60/975,499, filed on Sep. 26, 2007.

(51) Int. Cl. A63F 13/00; A63F 13/02; A41D 19/00

(52) U.S. Cl. 463/39; 273/148 B; 2/167

(57) ABSTRACT

Interactive handwear devices and methods are disclosed for providing play entertainment. In certain examples, the handwear device includes a waterproof glove that a play participant can manipulate to selectively activate one or more play effects, such as water play effects, visual or audio effects, or the like. For instance, a participant may wirelessly trigger effects by moving the glove in one or more predetermined or particular motions and/or by touching one or more sensors. In yet other examples, a wide variety and/or magnitude of effects can be activated through interaction with one or more handwear devices and/or hand movements. User identities and/or progress in an interactive game can be also stored in one or more databases and be used to determine the availability of effects to a participant or group of participants.

### REFERENCE TO RELATED APPLICATION

The present application claims the benefit of priority under 35 U.S.C. § 119(e) of U.S. Provisional Patent Application No. 60/975,499, filed on Sep. 26, 2007, and entitled “MAGICAL GLOVE AND INTERACTIVE PLAY EXPERIENCE,” the entirety of which is hereby incorporated herein by reference to be considered part of this specification.

### BACKGROUND

1. Field

Embodiments of the present disclosure relate to interactive toys, games, and play systems in a water park or water play environment.

2. Description of the Related Art

Recent years have seen a proliferation of commercial play structures that provide an exciting alternative to traditional parks and playgrounds. Certain play structures include multiple play areas or stations in which participants may engage in educational and/or interactive activities. For instance, many play structures include ball pits, ropes, ladders, water guns, and the like.

Moreover, certain amusement parks have incorporated water-oriented themes and structures that provide people with an option to temporarily escape from uncomfortably hot conditions. Such parks often offer a fun environment for the participants, observers and others. For instance, certain water parks include popular entertainment facilities featuring play areas within and around water. Available activities may include water slides, splash pads, recreational bathing, swimming, and wave pools.

### SUMMARY

There is a continuing demand, however, for more exciting and entertaining experiences, as well as toys and games that increase the learning and entertainment opportunities for children to stimulate creativity and imagination. In light of the foregoing, a need exists for water play apparatus and methods that provide an interactive environment for play participants. For example, a need exists for interactive water play systems and methods that allow play participants to wirelessly activate with one or more water play effects.

In view of the foregoing, in certain embodiments of the invention, a play participant is able to manipulate handwear, such as a waterproof glove device, to selectively activate one or more water play effects. For example, a participant may wirelessly trigger the water play effects by moving the glove in one or more predetermined or particular motions. In yet other embodiments, a wide variety and/or magnitude of water play effects can be activated through interaction with one or more glove devices and/or glove movements.

In certain embodiments, a system is disclosed for providing water play entertainment to one or more play participants. The system comprises a body of water, at least one sensor and a glove configured to be worn by a play participant, the glove further configured to transmit a first wireless signal. The system further comprises an actuatable device in communication with the at least one sensor, the actuatable device configured to cause one or more water play effects with respect to the body of water, wherein at least one of the actuatable device and the at least one sensor is disposed in, on, or around the body of water. In addition, the system comprises a database in communication with the at least one sensor, wherein the database includes at least one association between an identity of a user of the glove and at least one of the first wireless signal, the at least one sensor, and the one or more water play effects, and, wherein, in response to the at least one sensor receiving the first wireless signal from the glove, the actuatable device performs a selected one of the one or more water play effects in accordance with the at least one association stored in the database.

In certain embodiments, a method is disclosed for providing interactive game play within a water play environment. The method comprises providing handwear configured to transmit at least one wireless signal in response to activation of the handwear by a play participant during an interactive game and providing a plurality of sensors, each of the plurality of sensors configured to receive the at least one wireless signal from the handwear when the handwear is within a particular distance thereof. The method further comprises providing a plurality of electronically actuatable devices in communication with the plurality of sensors, wherein at least one of the plurality of electronically actuatable devices is disposed in, on, or around a body of water, and wherein the at least one electronically actuatable device is configured to provide a water play effect. In addition, the method comprises providing a database storing at least one association between the handwear and at least one of the at least one wireless signal, at least one of the plurality of sensors, and at least one of a plurality of play effects associated with the plurality of electronically actuatable devices; and providing a control module in communication with the database, the plurality of sensors and the plurality of electronically actuatable devices, the control module being configured to, based at least on the at least one association in the database, selectively instruct one or more of the plurality of electronically actuatable devices to provide one or more of the plurality of play effects in response to one or more of the plurality of sensors receiving the at least one wireless signal from the handwear.

In certain embodiments, a system is disclosed for providing interactive game play within a water play environment. The system comprises handwear means for transmitting at least one wireless signal in response to activation of the handwear means by a play participant during an interactive game and means for receiving the at least one wireless signal from the handwear means when the handwear means is within a particular distance thereof. The system further comprises: (i) means for actuating a plurality of play effects including at least one water play effect, the actuating means being in communication with the receiving means and being disposed in, on, or around a body of water; (ii) means for storing an association between the handwear means and at least one of the at least one wireless signal, the receiving means, and at least one of the plurality of play effects; and (iii) means for instructing, based at least on the association, one or more of the means for actuating to trigger one or more of the plurality of play effects in response to one or more of the receiving means receiving the at least one wireless signal from the handwear means.

In certain embodiments of the invention, a toy glove is disclosed for use in an interactive water play environment. For instance, the glove may be configured to communicate with one or more sensors and/or actuators to cause one or more play effects. In certain embodiments, the play effects can include one or more of the following: dumping a bucket of water, activating a pipe fall or waterfall, activating one or more geysers or jets of water, one or more waterslide effects, or the like. Such communication can advantageously include wireless communication (for example, broadcast signals and/or signals based on particular motion(s) of the glove) and/or direct contact between the glove and a sensor and/or actuator. Moreover, multiple gloves can be used to control the type and/or magnitude of the one or more play effects.

In certain further embodiments, the glove is configured to store identification information that uniquely identifies the glove and/or the user. Such identification information can be advantageously transmitted by the glove during communication with sensors. Moreover, the identification information can be used to select the type and/or magnitude of a play effect, to identify the location of a play participant, and/or to keep track of the progress of a play participant or group of participants during a game.

In certain embodiments, an interactive water attraction is disclosed for entertaining one or more play participants. The interactive water attraction comprises: a body of water; a glove configured to send at least one signal to at least one of a plurality of sensors; a plurality of actuatable devices in communication with the plurality of sensors, wherein at least one of the actuatable devices and the sensors are disposed in, on, or around the body of water; and a database in communication with the sensor. The database includes at least one association between an identity of a user of the glove and at least one of the signal, the sensors, and a plurality of related actions of the actuatable devices. Upon receiving the signal from the glove, the sensor sends an instruction to a selected actuatable device to perform a selected action in accordance with the allowed actions recorded within the database.

In certain embodiments, a toy is disclosed for use in interacting with water park attractions. For example, the interactive toy can comprise a glove, a communication mechanism housed within or attached to the glove, wherein the communication mechanism communicates with a plurality of sensors such that a selected communication received by the sensors from the communication mechanism induces at least one selected process in a plurality of actuatable devices. Moreover, at least one of the actuatable devices and the sensors can be disposed in, on, or around a body of water, and at least one interface housed within or attached to the glove can allow a user of the glove to cause the communication mechanism to send a selected communication to the sensors. In certain embodiments, communication between the communication mechanism and the sensors conveys at least an identifier that uniquely identifies the toy.

In certain embodiments, a method is disclosed for personalized interaction within a water park environment. The method comprises providing a glove configured to send at least one signal that can be received by sensors in communication with actuatable devices, wherein at least one of the actuatable devices and the sensors is disposed in, on, or around a body of water. The method further includes providing a database in communication with the sensors, wherein the database includes at least one association between the glove and at least one of the signal, the sensors, and a plurality of allowed actions of the actuatable devices. The method also includes instructing at least one of the actuatable devices to perform a selected action by sending a first signal from the glove to a selected sensor, wherein the selected action is in accordance with the allowed actions recorded within the database; recording at least one action instructed by the glove; and updating the database to change at least one of the recorded associations and the plurality of allowed actions of the actuatable devices based upon the recorded actions.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 illustrates a block diagram of a water park attraction usable with an interactive glove device, according to certain embodiments of the invention.

FIGS. 2A-2E illustrate embodiments of actuatable features usable with the water park attraction and interactive glove device of FIG. 1.

FIG. 2F illustrates an embodiment of a scoreboard usable with the water park attraction and interactive glove device of FIG. 1.

FIG. 3 illustrates exemplary embodiments of particular movements that can be employed by the interactive glove of FIG. 1 to induce actuation of selected actuatable features of a water park attraction.

FIG. 4 illustrates an exemplary flowchart of an interactive water play process employed by the interactive glove of FIG. 1.

FIGS. 5A and 5B illustrate additional exemplary embodiments of the interactive glove of FIG. 1.

FIGS. 6A-6H illustrate exemplary embodiments of water park attractions that can employ the interactive glove of FIG. 1 and/or the actuatable features of FIGS. 2A-2E to provide an interactive water park environment. In particular, FIG. 6A illustrates a waterslide; FIG. 6B illustrates a video playback and recording system; FIGS. 6C and 6D illustrate a water raft ride; FIG. 6E illustrates a water raft combat game; FIGS. 6F and 6G illustrate a treasure hunt game; and FIG. 6H illustrates a play structure, according to certain embodiments of the invention.

FIG. 7 illustrates an exemplary embodiment of a home computer system configured to interact with the interactive glove of FIG. 1.

FIG. 8 illustrates embodiments of home water toys and water spaces configured to interact with the interactive glove of FIG. 1.

FIGS. 9A-9T illustrate exemplary embodiments of gloves, wristbands and other handwear usable with embodiments of the invention.

### DETAILED DESCRIPTION OF CERTAIN EMBODIMENTS

Embodiments of the present disclosure relate to interactive toys, games, and play systems in a water park or water play environment that utilize an interactive glove configured to actuate elements of the water park or water play environment, thereby providing an interactive water play experience.

For instance, in certain embodiments, a play participant is able to manipulate a waterproof glove device to selectively activate one or more water play effects. For example, a participant may wirelessly trigger the water play effects by moving the glove in one or more predetermined or particular motions. In yet other embodiments, a wide variety and/or magnitude of water play effects can be activated through interaction with one or more glove devices and/or glove movements.

The features of the systems and methods will now be described with reference to the drawings summarized above. Throughout the drawings, reference numbers may be re-used to indicate correspondence between referenced elements. The drawings, associated descriptions, and specific implementation are provided to illustrate embodiments of the invention and not to limit the scope of the disclosure.

In addition, methods and functions described herein are not limited to any particular sequence, and the blocks or states relating thereto can be performed in other sequences that are appropriate. For example, described blocks or states may be performed in an order other than that specifically disclosed, or multiple blocks or states may be combined in a single block or state.

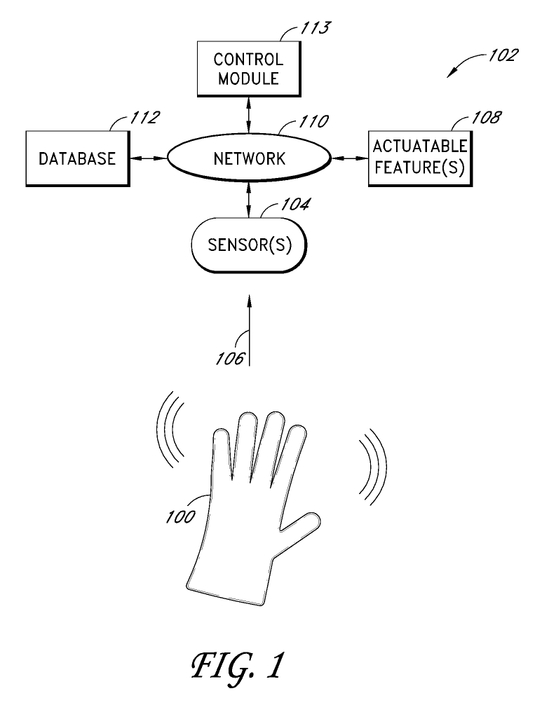

FIG. 1 illustrates handwear, such as an interactive glove 100, that interacts with one or more water park attractions 102 to provide enhanced and personalized water park experiences, according to certain embodiments of the invention. In certain embodiments, the glove 100 is worn by a water park guest and allows the guest to interact with the water park attractions 102. For example, the guest may use his or her glove 100 to achieve desired goals or produce desired effects in the water park attractions 102. Such interaction may deeply engage the guest in the water park experience, enhancing his or her enjoyment and encouraging repeat visits.

In further embodiments, the use of the glove 100 may optionally serve to identify the guest and/or group or team of guests and, on the basis of this identification, adapt the function of at least a portion of the play effects that the guest may cause the water park attractions 102 to perform. For example, frequent guests may be rewarded with the ability to produce play effects with the glove 100 in the water park attractions 102 that are not otherwise achievable by first-time guests. Thus, embodiments of the invention may further enhance the experience of frequent water park guests and build customer loyalty. These and other objects and advantages of the present disclosure are discussed in greater detail below.

The illustrated interactive water park attraction 102 comprises, in an embodiment, at least one receiver or sensor 104 configured to receive at least one signal 106 transmitted by the glove 100 and at least one actuatable feature 108 configured to activate one or more effects in response to the signal(s) 106 received by the sensor(s) 104. The sensor(s) 104 and actuatable feature(s) 108 are further in communication over a communications network 110, such as a wired and/or wireless network.

As discussed in greater detail below, the signal(s) 106 can comprise wireless signals and/or gestures, and the actuatable features 108 can comprise any combination of audio, visual, and other actuatable effects. For example, in certain embodiments, the sensor(s) 104 can comprise one or more receivers or transceivers, such as radio frequency receivers or transceivers. In other embodiments, the sensor(s) can comprise an infrared sensor, a motion detector, a barcode reader, combinations of the same or the like

In an alternative embodiment, the sensor(s) 104 comprise pressure sensors, and the signal(s) 106 comprise physical contact between the glove 100 and the sensor 104. In certain embodiments, each of the sensors 104 corresponds to at least one actuatable feature 108 and, when the sensor 104 receives the signal 106 from the glove 100, at least one actuatable feature 108 is instructed, over the communications network 110, to perform at least one play effect.

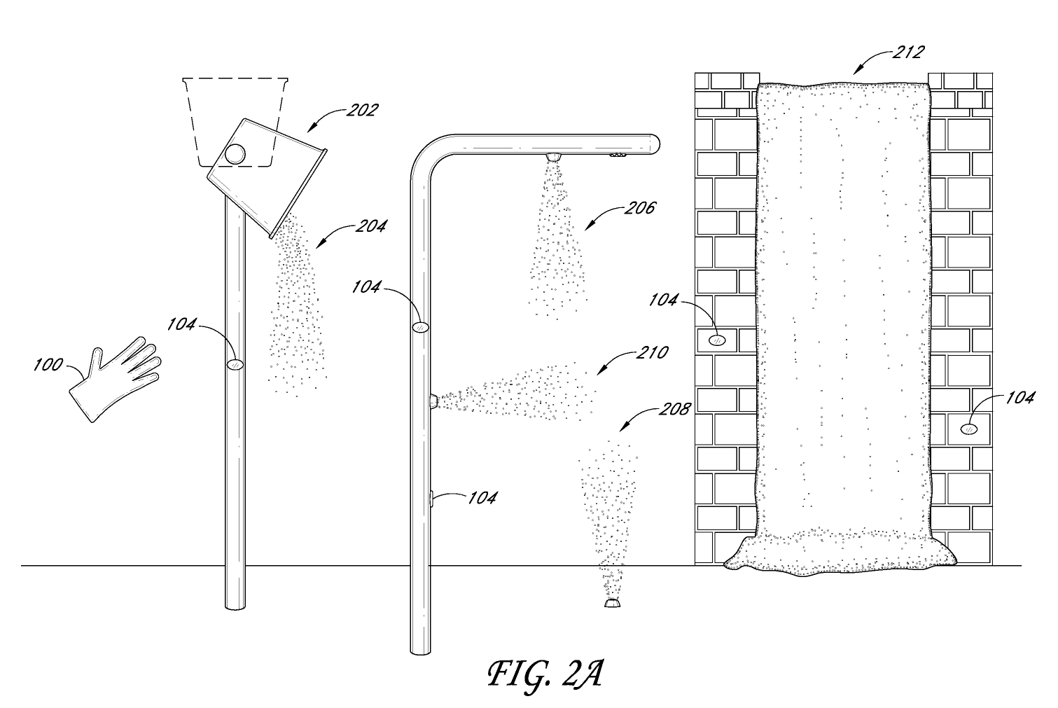

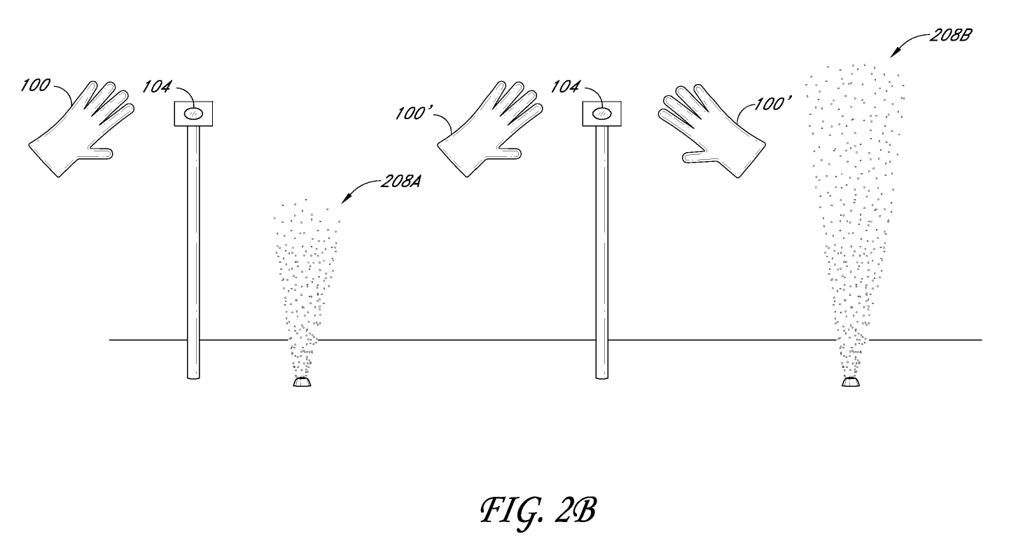

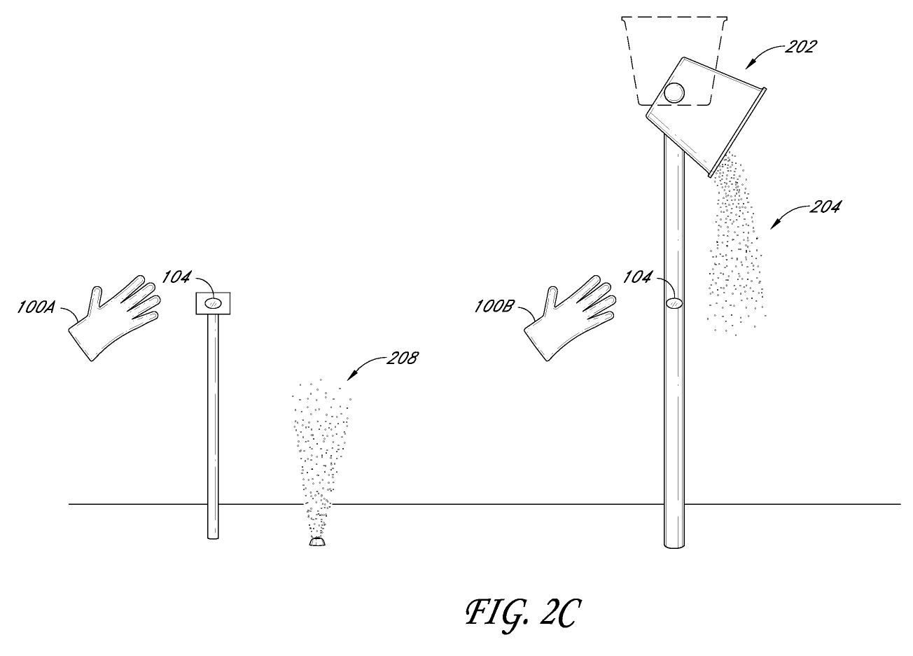

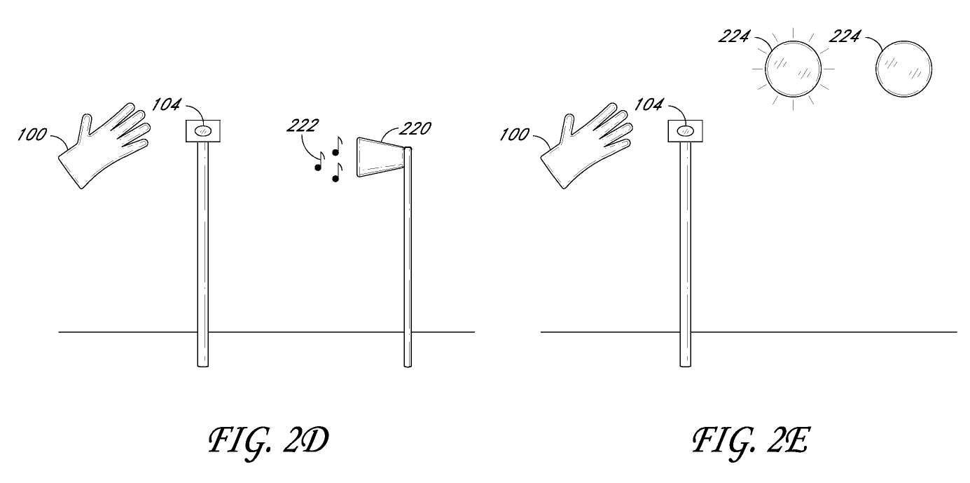

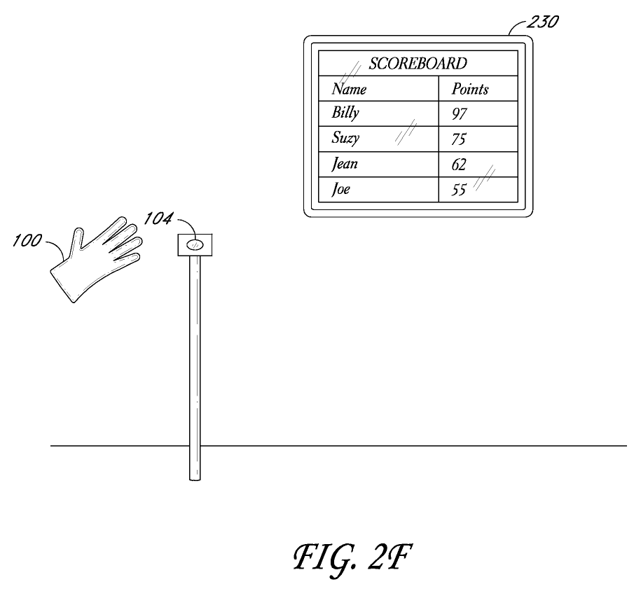

FIGS. 2A-2E illustrate particular examples of the actuatable features 110 an play effects that can be activated by signals 106 generated by the glove 100 and received by sensor(s) 104. As illustrated in FIG. 2A, the actuatable features can comprise water-based effects. In one example, the actuatable feature can comprise a bucket 202 holding water 204. Activation of the bucket 202 can cause the bucket 202 to tip over, pouring out the water 204. The bucket 202 may further vary in size, as necessary to hold a desired volume of water 204. For example, a bucket 202 that is designed to deliver a modest volume of water 204 on a guest can configured to hold between one to ten gallons of water 204. In other examples, a bucket 202 designed to thoroughly wet a large party of guests may be configured to hold in excess of 1000 gallons.

In another example, the actuatable feature comprises water jets of varying orientation. Such water jets may include ceiling jets 206 that direct a spray of water generally downward, floor jets 208 that direct a spray of water generally upward, and/or wall jets 210 that direct a spray of water generally sideways. In a further example, the actuatable feature may comprise a waterfall 212.

The magnitude of the water-based effects of FIG. 2A can be varied in certain embodiments, as illustrated in FIG. 2B. For example, when using the glove 100 to communicate with the sensor 104, a floor water jet 208A may spray water at a first height. Use of two gloves 100′ to generate signals, however, can cause a floor water jet 208B to spray at a second height higher than the first height. In certain embodiments, the floor water jet 208B sprays the second height only when both gloves 100′ transmit their respective signals within a particular time period, such as, for example, two seconds and/or from within a particular distance of the sensor 104. In yet other embodiments, the floor water jet 208B is configured to spray at the second height when the signals transmitted by the two gloves 100′ are received, respectively, by two different sensors 104.

A plurality of actuatable features can also be activated concurrently by use of a plurality of gloves 100. For example, as illustrated in FIG. 2C, a first glove 100A may be employed by a guest to generate a signal that activates a water jet 208. A second glove 100B may be concurrently employed by the same guest or another guest to generate a signal that causes a water bucket 202 to tip and spill the water 204.

As illustrated in the embodiments of FIGS. 2D and 2E, actuatable features can further comprise audio and/or visual effects. For example, the feature can comprise a speaker 220 that emits sounds 222, such as voices, tones and songs. In another example, the feature may comprise one or more lights 224, which display, for example, a plurality of colors in selected patterns.

FIG. 2F illustrates an embodiment of a scoreboard 230 usable with the water park attraction 102 and/or interactive glove 100 of FIG. 1. For example, the scoreboard 230 can display the names of one or more guests participating with the water park attraction 102 and/or one or more corresponding scores (for example, individual scores and/or team scores). In certain embodiments, the scores can be generated based on the results of one or more games and/or completed tasks or challenges, as discussed in more detail below.

Although particular embodiments of actuatable features are disclosed with reference to FIGS. 2A-2F, other types of features are also usable with embodiments of the invention. For example, in certain embodiments, one or more of the actuatable features comprises a nozzle, a spray, a fountain, combinations of the same or the like. In other embodiments, an actuatable feature can comprise a video display or like device that produces a visual image or sequence of images (for example, a video) in response to one or more signals 106 communicated from the glove 100 to one or more sensors 104.

In one embodiment, the signals 106 may comprise a plurality of wireless signals. Such wireless signals can include, but are not limited to, laser signals, radio frequency (RF) signals (including BLUETOOTH communication), and infrared (IR) signals. In certain embodiments, the wireless signals can be generated in response to guest activation of the glove 100. In alternative embodiments, as discussed in greater detail below, the wireless signals can be generated automatically by the glove 100 without guest action. In addition, the signals 106 can advantageously comprise two-way communication between the glove 100 and the sensor(s) 104 and/or the actuatable feature(s) 108.

In other embodiments, the sensor 104 can be at least configured to sense motion, and/or the signal 106 can be based on or triggered by one or more particular motions or gestures 300 of the glove 100. For example, the gestures 300 can comprise patterns, such as open or closed geometric shapes, as illustrated in FIG. 3. Such gestures 300 can be performed in isolation or in combination in order to provide a particular signal 106.

Thus, in one embodiment, the gesture 300 can comprise a circle-like gesture, a triangle-like gesture, a square-like gesture, back and forth movement, waving, movement of select fingers, combinations of the same or the like. In another embodiment, the gesture 300 may be spatially dependent. For example, the gesture 300 can comprise a square-like gesture to the right of a triangle-like gesture. It should be understood, that these gestures are discussed for exemplary purposes and that the gesture 300 may comprise any pattern or motion capable of being recognized by the sensor 104.

Embodiments of the glove 100 may be further configured to provide signals comprising combinations of a particular wireless signal and a gesture 300. For example, the guest may employ the glove 100 to generate the particular wireless signal while the sensor 104 detects one or more gestures 300 of the glove 100. Alternatively, the wireless signals and gestures 300 may be performed in a selected sequence. For example, the signal 106 can comprise a wireless signal, followed by two selected gestures, then followed by another wireless signal.

In certain embodiments, the glove 100 comprises motion-sensitive circuitry configured to generate one of a plurality of signals based on one or more particular motions of the glove 100. For instance, the glove 100 may comprise one or more motion sensors (for example, tilt sensors), switches (for example, ball switches), accelerometers, gyroscopes or the like, useable to analyze and/or detect motion of the glove 100 by the guest. In such embodiments, different signal(s) transmitted by the glove 100 may be advantageously dependent upon the particular motion(s) of the glove 100.

In one embodiment, the sensor(s) 104 and actuatable feature(s) 108 are configured such that any wireless signal and/or gesture 300 generated by the glove 100 will cause the actuatable feature 108 to perform an effect. Such a configuration may be employed in circumstances where the actuatable feature 108 may be able to perform only one effect or may cycle through a plurality of effects.

In an alternative embodiment, the sensor(s) 104 and actuatable feature(s) 108 are configured such that a selected signal received by the sensor 104 corresponds to a selected effect of the actuatable feature 108. In an embodiment, the sensor 104 may include programmed logic that associates an effect of a selected actuatable feature 108 with a selected signal received by the sensor 104. Should the sensor 104 receive a signal 106 that is not the selected signal, the actuatable feature 108 may perform no effect and/or indicate that the selected signal was not received.

In certain embodiments, the sensor(s) 104 associated with the actuatable feature(s) 108, and the effects that may be generated by the particular actuatable feature 108, may be varied, depending on the identity of the guest. For example, the glove 100 may be configured such that the signals 106 generated by the glove 100 include information identifying the guest.

In yet other embodiments, the type and/or magnitude of the effect may depend, at least in part, on the particular motions or gesture 300 performed by the user. For instance, in certain embodiments, more complicated gestures 300 may cause greater and/or more complex effects.

The sensor(s) 104 and actuatable feature(s) 108 of the water park attraction can further be in communication, through the communications network 110, with a database 112 (FIG. 1). In certain embodiments, the database 112 comprises at least one data structure that includes at least one association between a guest, the sensor(s) 104, the actuatable feature(s) 108, and/or a plurality of related actions of the actuatable features 108. The database 112 may be incorporated into the sensor 104 or may be stored on a separate device, such as a server computer.

Advantageously, the associations within the database 112 may allow the water park environment to be personalized to the guest. In an embodiment, when the sensor(s) 104 receive a selected signal 106, the signal is conveyed to the database 112. The database 112 correlates the signal 106 and the guest's identity, as well as the sensor(s) 104 that received the signal 106, with a plurality of actuatable features 108 and associated effects. This correlation determines, based upon the guest, what effect the selected signal 106 activates in the actuatable feature(s) 108. Thus, a selected signal 106 generated by one guest may cause a first effect to be produced in an actuatable feature 108, while the same signal 106 generated by a different guest may produce a second effect in the same actuatable feature 108.

The database 112 may further store information pertaining to the guest's actions in the water park in order to develop guest preferences. For example, the guest may be provided with a plurality of songs from which to select from when enjoying a water park attraction. A frequently selected song may be identified as a preference of the guest. Subsequently, as a default, when the water park attraction identifies the guest, the music preference may be played.

In additional embodiments, the stored information may be used to reward the guest and/or team of guests. For example, rewards may be awarded to the guest based upon completion of a series of tasks, such as activating a selected number of actuatable features of a water park attraction. Alternatively, rewards may be awarded for being the high scorer in a water park game, as discussed below. Such rewards may further be awarded to a guest based upon play employing their glove 100 at various water park attractions within a single water park, and even at different water parks supporting the glove 100.

In certain embodiments, the water park attraction 102 of FIG. 1 further comprises a control module 113 that directs which play effects are activated based on signal(s) received from the glove(s) 100 and/or data or preferences stored in the database 112. For example, in certain embodiments, the control module 113 is in communication with the sensor(s) 104 and at least one of the actuatable feature(s) 108 and the database 112. In certain embodiments, the control module 113 can be configured to receive signals from the sensor(s) 104, access the database 112 and instruct one or more of the actuatable features 108 to trigger one or more particular effects. In certain embodiments, the control module 113 can comprise a stand-alone computing device, a software module, and/or can be at least partially integrated into at least one of the sensor(s) 104, the actuatable feature(s) 108 and the database 112.

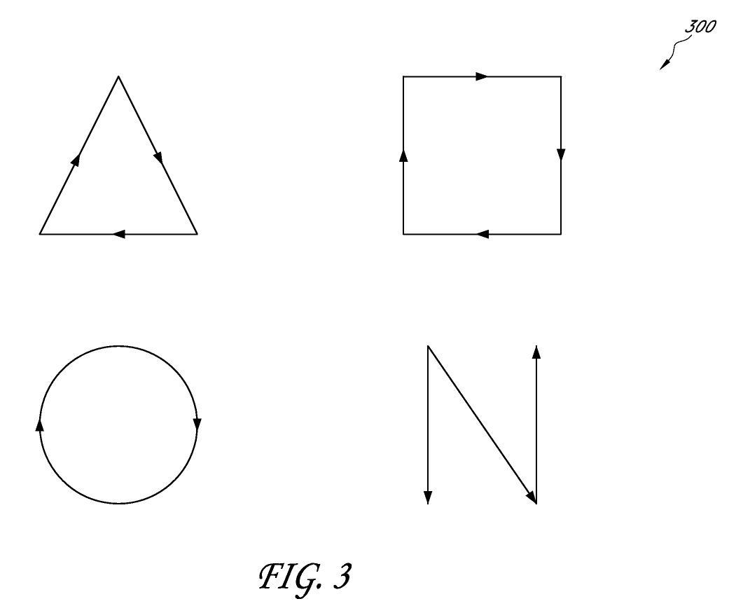

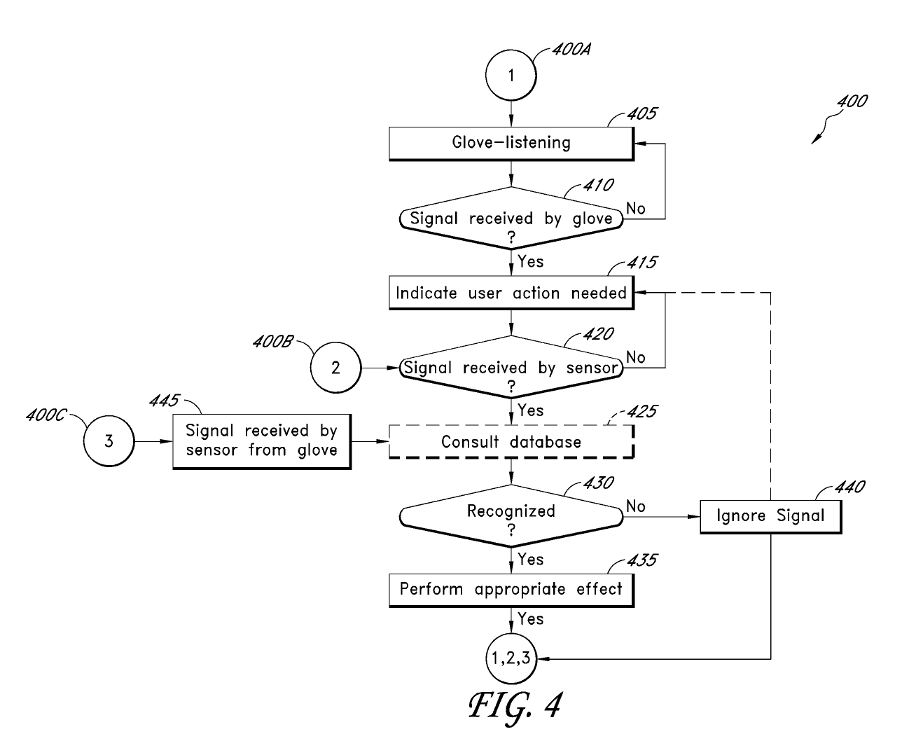

FIG. 4 illustrates a flowchart of an exemplary embodiment of a water play process 400 that can be employed using the interactive glove 100 of FIG. 1 in connection with one or more water park attractions. As shown, the water play process 400 comprises at least three routines that begin, respectively, at states 400A, 400B and 400C.

In particular, a first routine begins at state 400A and is applicable when the glove 100 waits for a signal from the environment and indicates to the guest that an action is required. A second routine begins at state 400B and is applicable in situations where the guest activates the glove 100 to generate a signal in the absence of a prompt. A third routine begins at state 400C and is applicable when a signal is generated by the glove 100 in the absence of a guest action.

With respect to the first routine, at Block 405 the glove 100 is in a “listening mode.” In the listening (or passive) mode, the glove is prepared to receive at least one signal from the water park environment. Moving to Block 410, the first routine determines whether or not a signal has been received by the glove 100. If no signal has been received, the first routine loops back to Block 405, where the glove 100 continues to listen until at least one signal is received.

At Block 415, when a signal is received by the glove 100, the glove 100 indicates to the guest that an action is required. In general, such action may comprise activating the glove 100 in order to generate at least one signal 106 that activates at least one effect in an actuatable feature 108. The indication, in certain embodiments, may be provided by a plurality of sensory indicators housed in the glove 100, discussed in greater detail below. Moving to Block 420, the first routine determines whether or not a signal 106 has been received by the sensor 104 from the guest's glove 100. Until a signal 106 is received, the first routine, loops back to Block 415, where the glove 100 indicates a guest action is required.

Once a signal 106 generated by the guest's glove 100 is received by the sensor 104 (Block 420), the signal is optionally sent to the database 112 in Block 425. In an embodiment, the database 112 determines whether or not the signal 106 is recognized in association with the guest (Block 430). For example, as discussed above, selected effects of an actuatable feature 108, in certain embodiments, may not be accessed by every guest. Thus, the database 112 (or a control module) determines whether or not the signal 106 generated by the guest is allowed to activate an effect in the actuatable feature 108. If so, the effect may be activated in Block 435, and the first routine returns to Block 405. Otherwise, the signal 106 is ignored in Block 440, and the first routine returns to Block 415 (dashed line), where the glove 100 indicates a user action is required.

In alternative embodiments, the sensor 104, rather than the database 112, determines whether or not the signal 106 is recognized. For example, as discussed above, the sensor 104 may be configured with programmed logic that recognizes only a selected set of signals in Block 430. If the sensor 104 recognizes the signal 106, the associated actuatable feature 108 is permitted to activate the appropriate effect in Block 435, and the first routine returns to Block 405. Otherwise, the signal 106 is ignored in Block 440, and the first routine returns to Block 415 (dashed line), where the glove 100 indicates a user action is required.

With respect to the second routine, at Block 420, the guest uses his or her glove 100 to provide at least one signal 106 to the sensor 104 in the absence of a prompt. The second routine subsequently proceeds as discussed above with respect to the first routine. After either an appropriate effect is performed in Block 435 or the signal 106 is ignored in Block 440, the second routine returns to Block 420.

With respect to the third routine, at Block 445, the glove 100 provides at least one signal 106 to the sensor 104 in the absence of action from the guest. Such circumstances may arise, for example, when the glove 100 automatically broadcasts a plurality of signals 106 identifying the identity of the guest without activation by the guest so as to provide one or more guest preferences. The third routine subsequently proceeds as discussed above with respect to the first and second routines. After either an appropriate effect is performed in Block 435 or the signal 106 is ignored in Block 440, the third routine returns to Block 445.

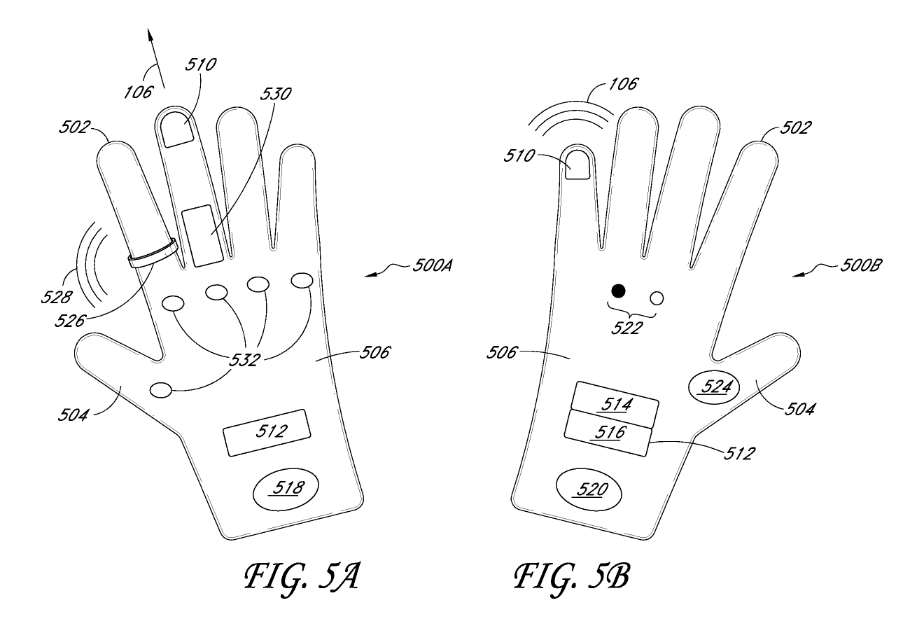

FIGS. 5A and 5B illustrate exemplary embodiments of an interactive glove for use in embodiments of the invention. As shown, gloves 500A and 500B are shaped so as to be worn upon the hand of a guest and comprise finger portions 502, thumb portions 504, and palm and wrist portions 506. The gloves 500A and 500B may be fabricated out of any material suitable for functioning within a water park environment, such as waterproof materials (for example, polymer-based materials) and other materials that are treated or coated with a waterproofing compound.

As illustrated, the gloves 500A and 500B further comprise a plurality of components that facilitate interaction between the guest utilizing the glove and the water park environment. In one embodiment, the gloves 500A and 500B comprise a communication mechanism 510 configured to generate, transmit, and/or receive the plurality of signals 106. The communication mechanism 510 may comprise a wireless communication mechanism, such as, for example devices (for example, transceivers) configured for wireless communication via RF signals (for example, a passive or active radio frequency identification (RFID) tag), infrared signals, laser signals, combinations of the same or the like.

In certain embodiments, the gloves 560A and 560B may further comprise a user interface 512. The user interface 512 may comprise at least one of a user selector 514 and a display 516. The user selector 514 comprises, in certain embodiments, a button, switch or other actuator that allows the guest to activate the communication mechanism 510, thereby generating the at least one signal 106. The display 516 may comprise any electronic display. Examples may include, but are not limited to, liquid crystal displays (LCDs), LEDs, or the like. In further embodiments, the wireless communication mechanism 510 may be configured to receive at least one wireless signal from the water park environment, causing selected information to be displayed on the display 516.

In certain embodiments, the glove 500A further comprises a plurality of sensory indicators 518 configured to be perceived by the guest employing the glove. The sensory indicators 518 may be activated in response to receipt of a plurality of signals by the communication mechanism 510 from the water park environment. For example, the water park environment may provide wireless signals that activate the sensory indicators 518 in order to create a mood or ambiance appropriate to a selected area of the water park in which the guest is present. Alternatively, the sensory indicators 518 may be activated in order to provide cues prompting the guest to perform a selected action using the glove.

As illustrated in FIG. 5B, the sensory indicators may comprise audio 520, visual 522, and/or tactile 524 indicators, or combinations thereof, which can be perceived by the guest. Audio indicators 520 may comprise devices, such as speakers, capable of providing audible sounds such as music, voices, and tones. Visual indicators 522 may comprise a plurality of lights configured to display a plurality of colors and patterns. Tactile indicators 524 may comprise components capable of providing a sensation that can be felt by the guest's hand. For example, such tactile indicators 524 may comprise devices that may produce varying pressures and/or temperatures. These sensory indicators may be further combined together, as necessary. For example, visual indicators 522 may display lights in selected colors and patterns alone or in combination with audible tones when prompting a guest to act.

In an embodiment, the glove 500A may further comprise a plurality of removable elements 526 that may be employed to enhance the functionality of the glove. For example, the removable element 526 may comprise a ring. In an embodiment, the removable element 526 may be activated in order to provide at least one wireless signal 528 that is different than the wireless signal 106 provided by the glove 500A. The wireless signal 528, alone or in combination with wireless signals 106 generated by the glove 500A, may allow the activation of effects in actuatable features that are not permitted using the wireless signals 106 generated by the glove alone.

In an embodiment, the glove 500A may further comprise a plurality of auxiliary glove sensors 530 configured to monitor the guest employing the glove. Such auxiliary sensors 530 may comprise sensors that provide measurements of at least one physiological parameter of the guest. The parameters may include, but are not limited to, heart rate, movement, temperature combinations of the same, or the like.

It may be further understood that, while not shown, the gloves 500A and 500B may further comprise any electronic components necessary to implement the elements discussed above and their respective features. Such electronic components may include, but are not limited to, processors, volatile and/or non-volatile memory, analog and/or digital circuitry, and/or power sources.

In further embodiments, the glove 500A may also be configured with a plurality of decorative features 532 that allow the guest to personalize the appearance of his or her glove. The decorative features 532 may include, but are not limited to, logos, runes, cosmetic jewelry such as gems, and pictures. In certain embodiments, the decorative features 532 may be reversibly attachable to the glove 500A, using mechanisms such as hook and loop fasteners or magnets, in order to facilitate easy personalization of the glove.

Although gloves 500A and 500B have been shown with respect to a full-hand glove configuration, in other embodiments of the invention a partial-hand glove configuration can be used. In yet other embodiments, the glove can comprise any device, clothing, handwear and/or wearable accessory that can attach to a hand and/or arm. For example, in certain embodiments, the wearable device comprises a wristband (such as, for example, a sweatband) that incorporates one or more features described herein with respect to the full-hand glove configurations.

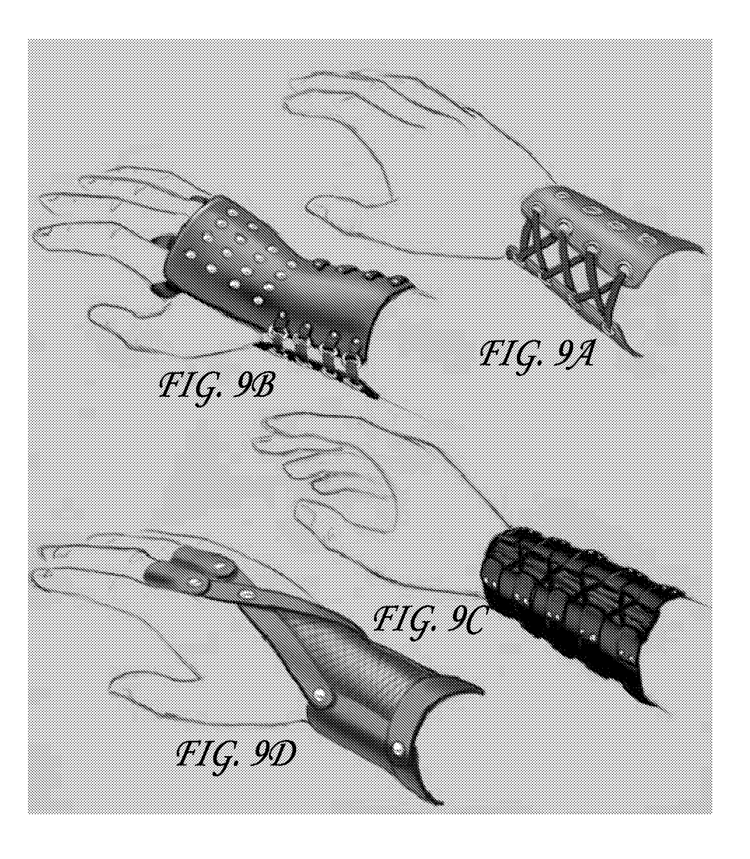

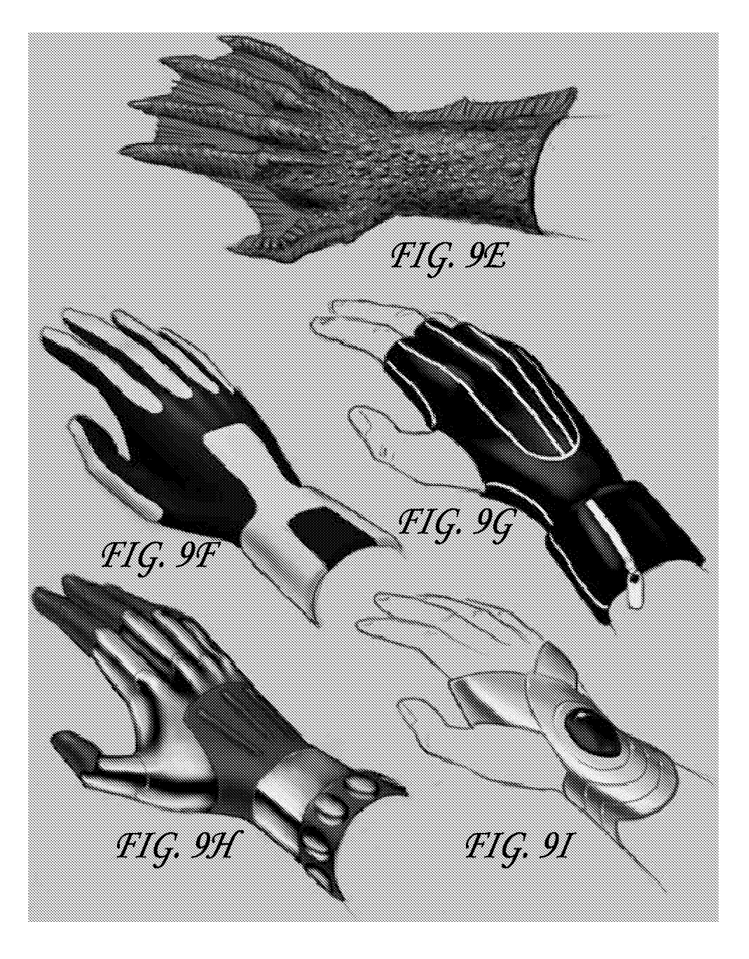

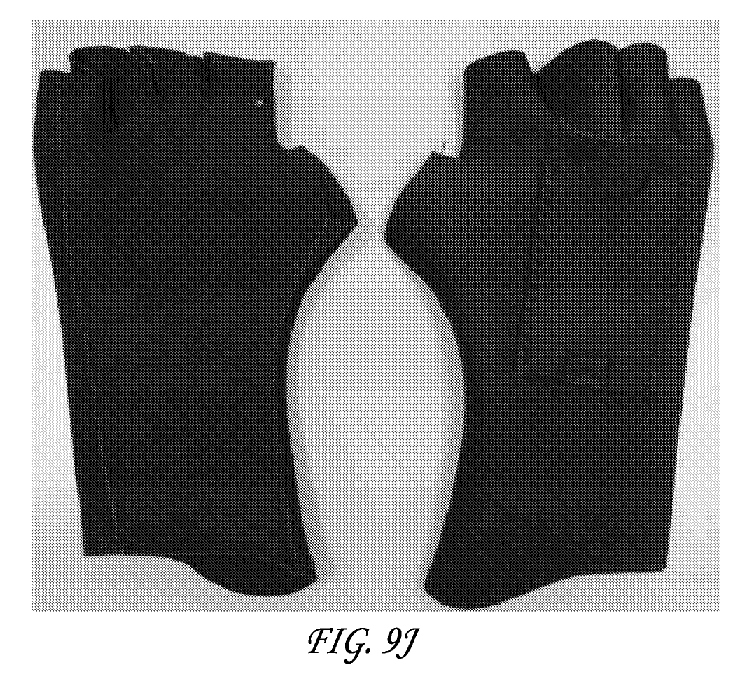

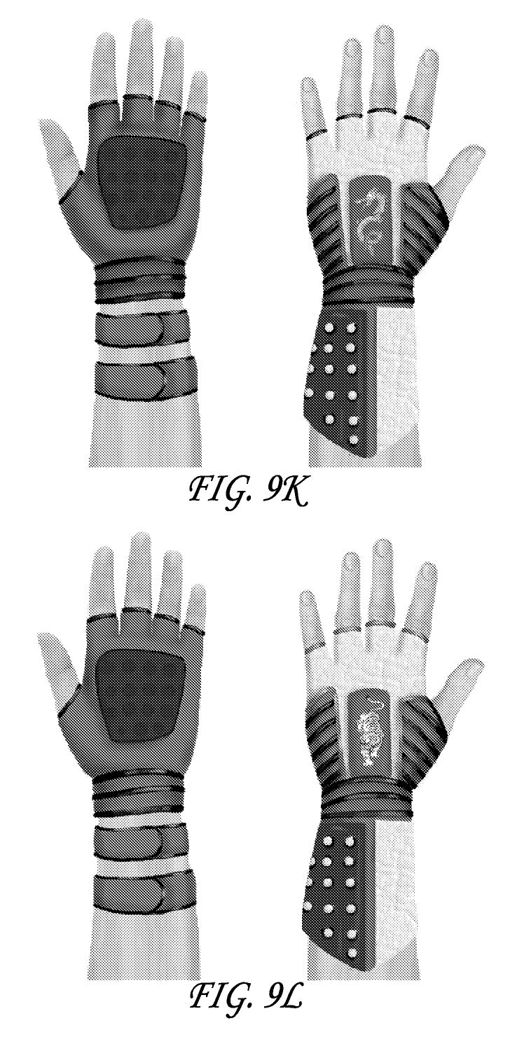

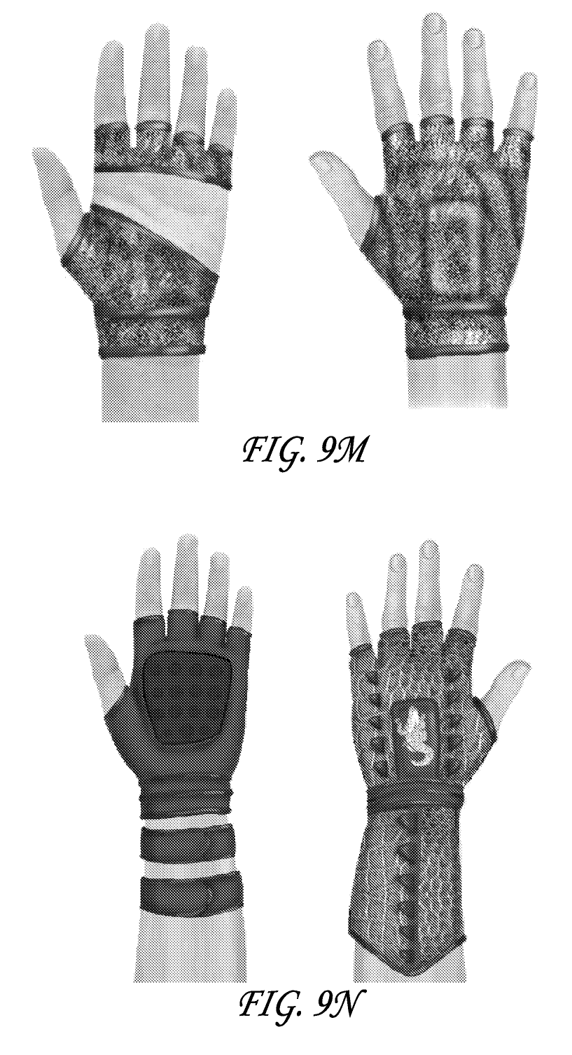

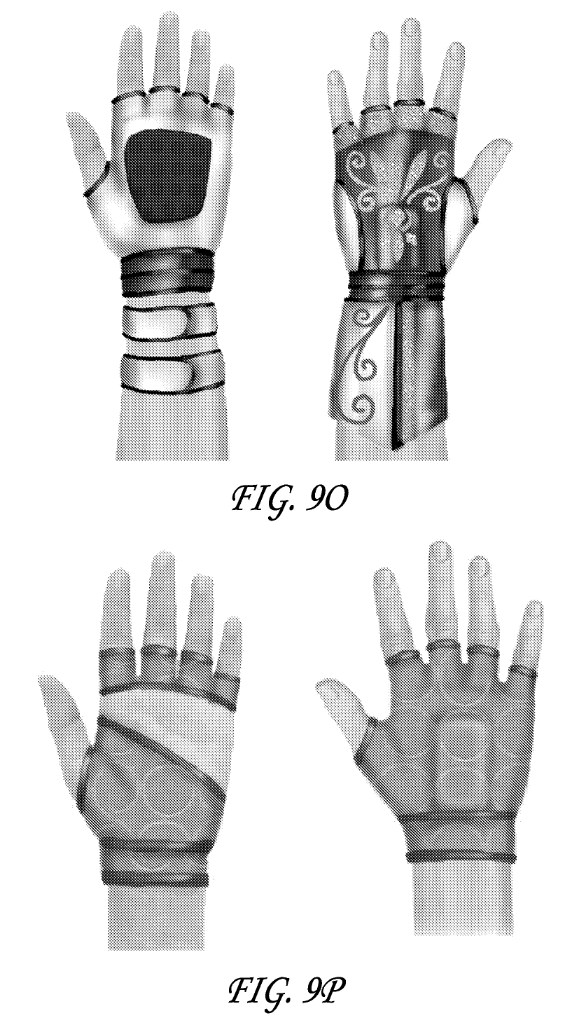

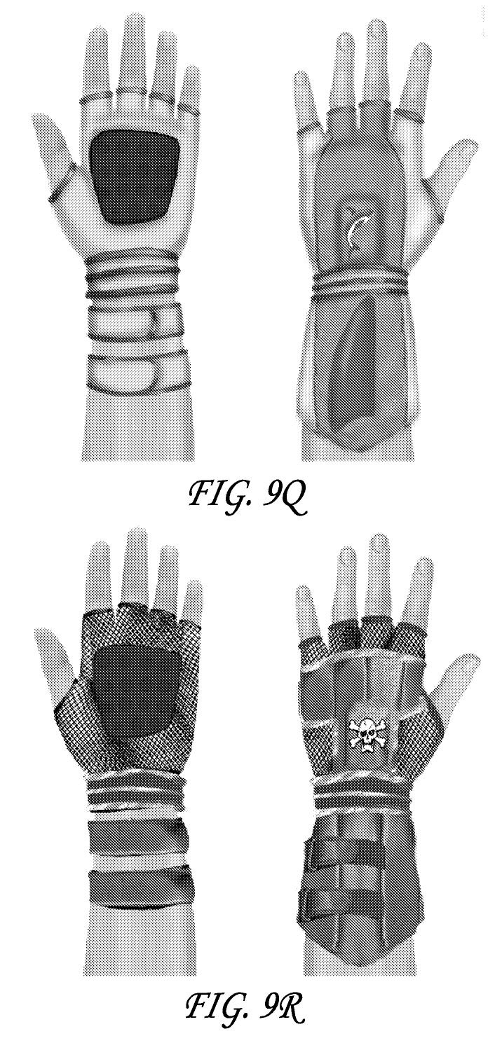

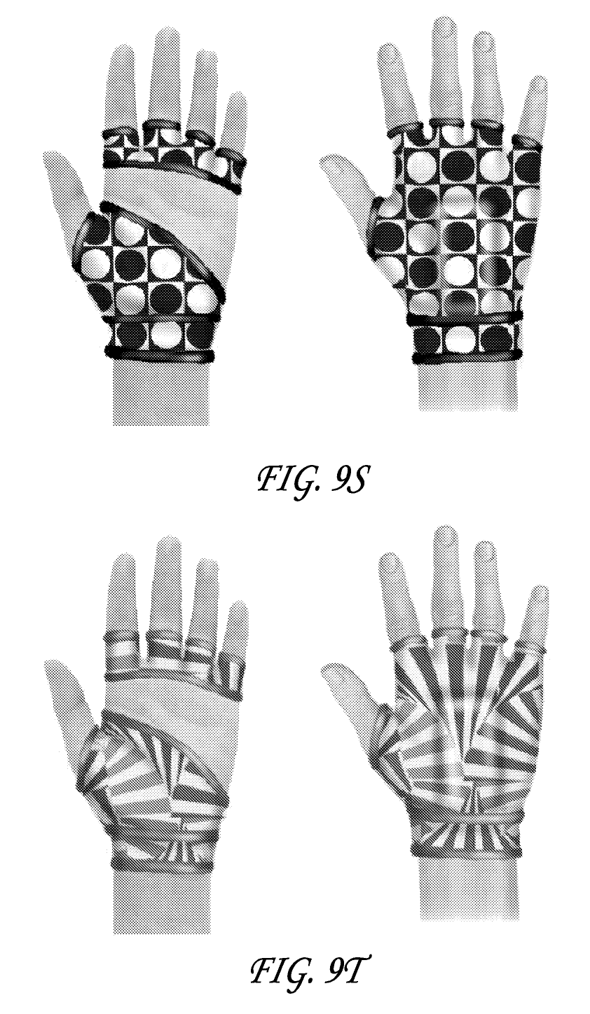

For instance, FIGS. 9A-9T illustrate exemplary embodiments of gloves, wristbands and other handwear usable with embodiments of the invention and/or that can include the inventive features and functions disclosed herein with respect to the glove devices of FIGS. 1-8. It will also be understood from the disclosure herein that other embodiments of the invention can take on other handwear configurations without departing from the scope of this disclosure.

In the following examples, use of embodiments of the disclosed interactive glove of the present disclosure in an interactive water park environment is discussed. In general, the examples illustrate the wide range of water park activities that may be enhanced through the use of the interactive glove. The examples further illustrate how embodiments of the interactive glove may be utilized to provide a personalized water park experience. It will be understood that these examples are discussed for illustrative purposes and should not be construed to limit the embodiments of the inventive features disclosed herein.

### Waterslide

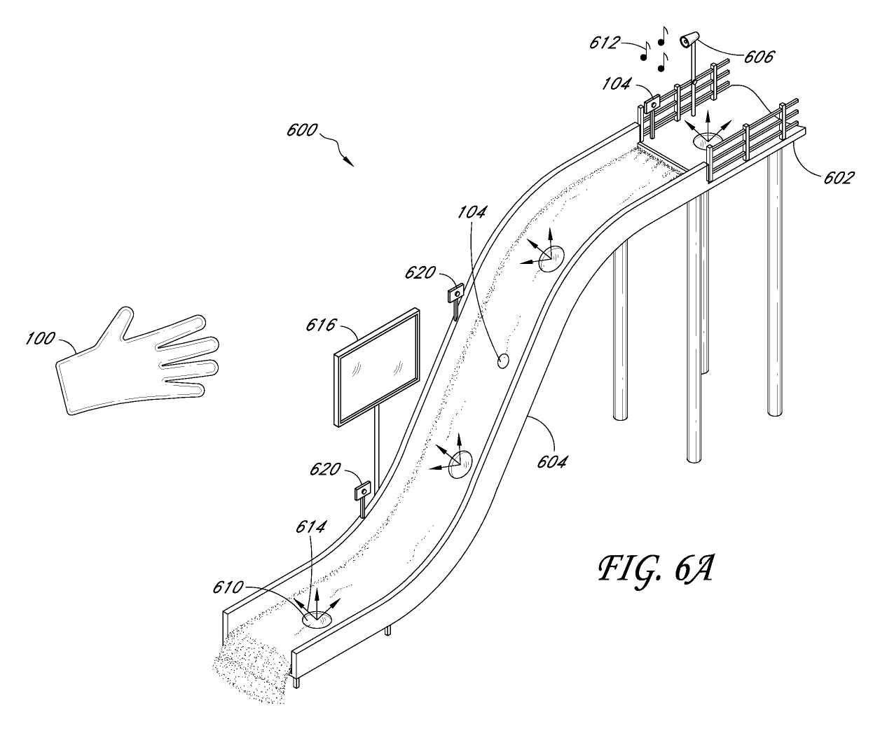

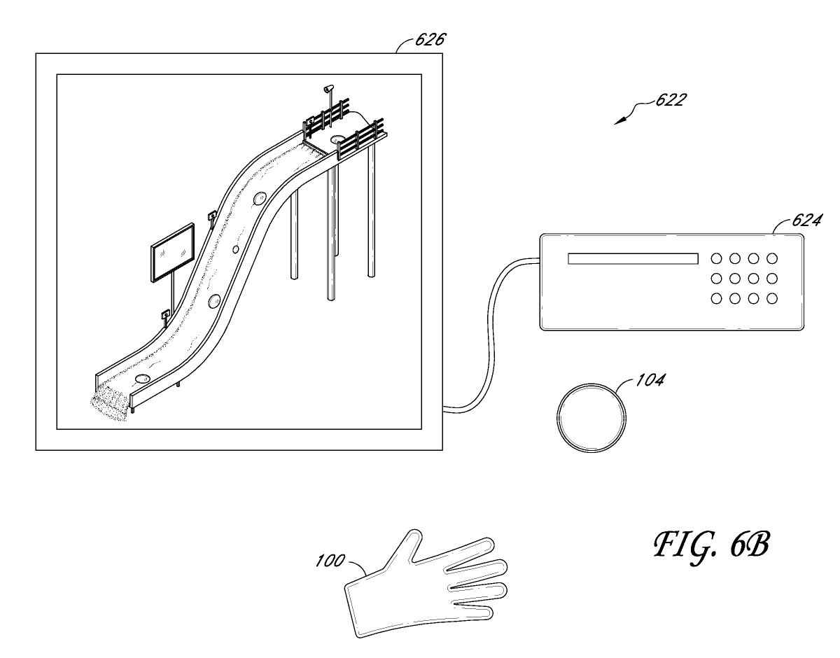

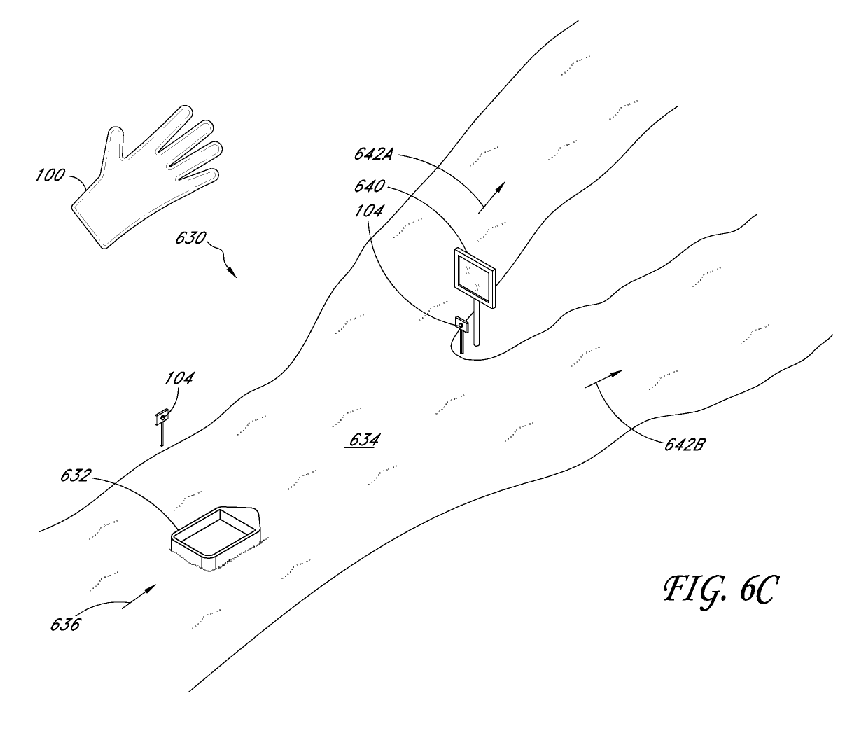

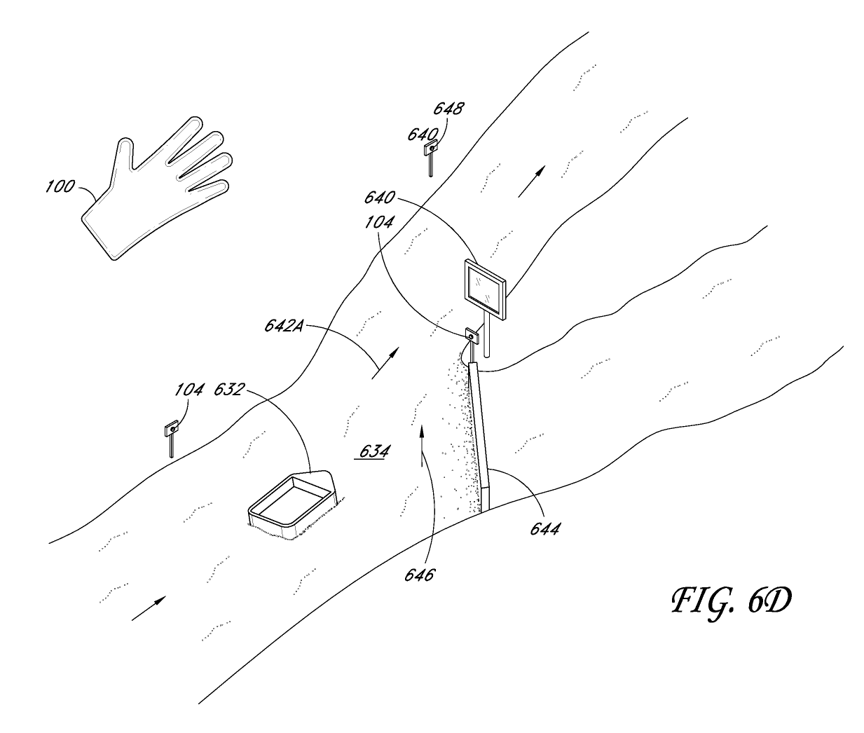

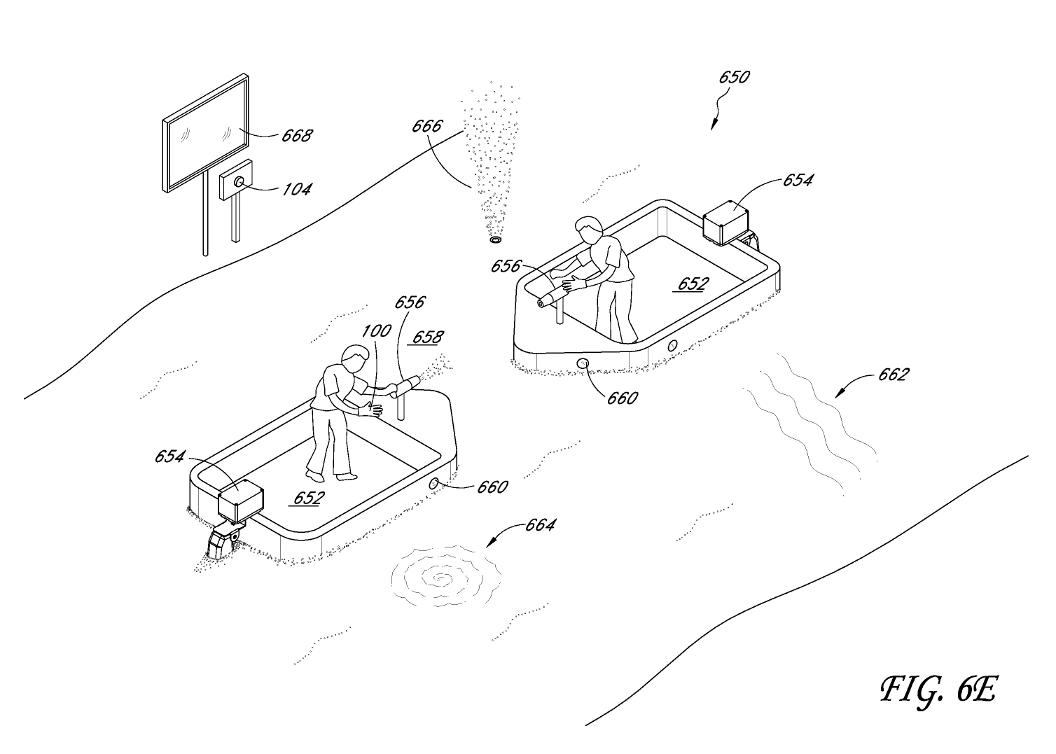

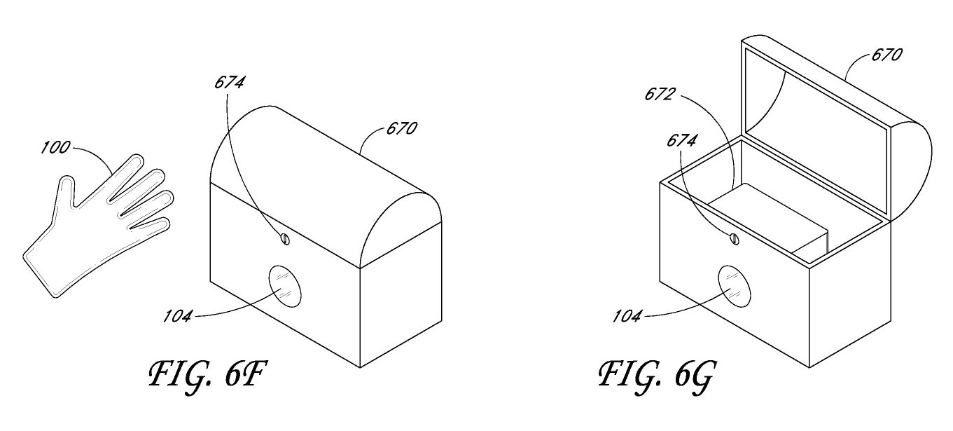

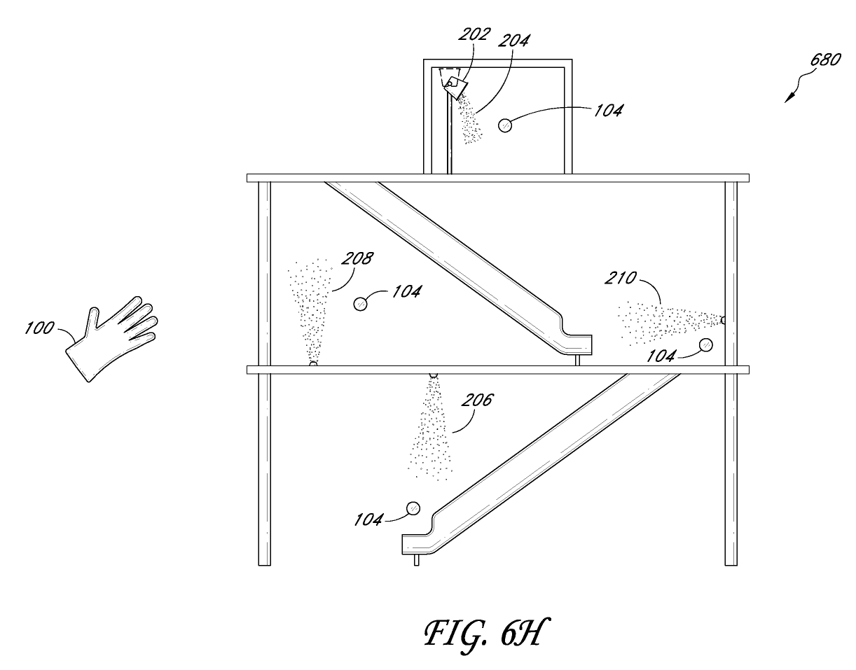

In one embodiment, the interactive glove 100 may be employed with a waterslide 600 (FIG. 6). The waterslide 600 comprises a staging area 602 where the guest enters and prepares to use the waterslide 600 and a ramp 604 that the guest slides down. The staging area 602 may be configured with a sensor 104 in communication with at least one actuatable feature comprising audio and/or visual device(s) 606, 610 that provide audio and/or visual effects, such as music and/or lighting effects 612, 614, while the guest employs the waterslide 600 attraction.

In one embodiment, the sensor 104 may also be in communication with at least one display device 616. The display device 616, in certain embodiments, may display a plurality of audio and/or visual effects that the guest may select to be performed while they use the waterslide 600. The display 616 may further indicate to the guest what signal they should provide in order to indicate a selected audio and/or visual effect 612, 614. The selected preference may also be saved to the database for future reference regarding the guest's preferences, as discussed above.

In one embodiment, the interactive glove 100 provides one or more wireless signals to the sensor 104 without guest activation of the glove 100. In general, these signals are generated in order to identify the guest when received by the sensor 104. Upon receiving the signal, the sensor 104 communicates with a database (not shown) to determine if the database has stored a musical and/or lighting effect preference for the guest. If such a preference is known, the database communicates this preference to the audio and/or visual devices 606, 610, which implement the guest's preference during use of the waterslide 600.

In an alternative embodiment, the interactive glove 100 may be activated by the guest in order to select a preferred audio and/or visual effect 612, 614. In one embodiment, this selection may be necessitated when no guest preference is found in the database. In another embodiment, this situation may arise when the guest provides a selected signal to the sensor 104. For example, the guest may choose to select a song different than his or her preference stored in the database.

Water park attractions such as the waterslide 600 may also be part of a reward system of the interactive glove 100. For example, the guest may receive rewards should they touch and/or activate a select number of waterside sensors 620 during use of the waterslide 600. Alternatively, a reward may be granted on the basis of number of times the waterslide 600 is used in a selected time period. Rewards may include, but are not limited to, additional audio and/or visual effects 612, 614 from which the guest may select during future use of the waterslide 600.

In certain embodiments, the display device 616 may additionally comprise a scoreboard that displays rankings or standings for a plurality of guests and/or groups of guests, before and/or after their use of the waterslide 600. Such play may comprise, for example, the results of a waterslide race or cumulative standings for competitions on a number of different water park attractions.

### Video Recording

In one embodiment, the interactive glove 100 may be employed with a water park attraction, such as the waterslide 600 of FIG. 6A and a video recording system 622. In certain embodiments, the video recording system 622 comprises a video recording device 624 in communication with one or more video cameras (not shown), which capture the guest's use of the waterslide 600, and a video display 626. In certain embodiments, the guest may approach a sensor 104 in communication with the recording system 622 and use the glove 100 to identify themselves either actively or passively. The guest may then view the video recorded from their use of the waterslide 600. In certain further embodiments, the guest can use the glove 100 to indicate whether they would like to purchase a copy of the video recording.

### Water Raft Ride

The interactive glove 100 may also be employed with a water raft ride 630, as illustrated in FIGS. 6C and 6D. The water raft ride 630, in one embodiment, comprises a water raft 632 that is propelled through a water channel 634 by water current 636. Within the water channel 634, the water raft 632 may encounter barriers that cause the channel 634 to fork.

At such forks, the guest may choose which direction the water raft 632 should travel, using the interactive glove 100. In one embodiment, signs 640, positioned to be viewed as the guest approaches the fork may indicate a first signal that, if provided by the glove 100, will cause the water raft 632 to move in a first direction 642A and a second signal, which if provided by the glove 100, will cause the water raft 632 to move in a second direction 642B. In such embodiments, a sensor 104 may be mounted adjacent the fork such that, when the guest provides the first or second signal within sensing range of the sensor 104, the watercraft 632 is propelled in the first or second direction 642A, 642B, respectively.

For example, when the guest provides the first signal to the sensor 104, indicating a preference that the water raft 632 move in the first direction 642A, one or more elements of the water raft ride 630 may be actuated in order to implement this decision. Such elements may include a barrier 644 that blocks the water raft 632 from traveling in the second direction 642B and/or a new current 450 that urges the water raft 632 in the first direction 642A.

The water raft ride 630 may also provide a plurality of reward features. For example, a plurality of water raft ride sensors 648 may be present within or adjacent the channel 634. By touching one or more selected ride sensors 648, the guest may accumulate rewards as discussed above.

### Water Raft Combat

The interactive glove 100 may also be employed with a head-to-head water raft combat game 650, as illustrated in FIG. 6E. In an embodiment, the combat game 650 comprises a plurality of combat rafts 652 equipped with engines 654 and water guns 656 that are free to move about in a water arena 658. Guests may score points by targeting one or more combat sensors 660 mounted upon the sides or bottom of their opponent's combat raft(s) 652 with jets of water. For example, the guest may employ his or her water guns 656 to score points.

In certain embodiments, the guests may use the interactive glove 100 in order to provide selected signals to a plurality of sensors 104 within the arena 658 to trigger a variety of environmental water effects. These effects may assist a guest in attempts to maneuver his or her opponents' raft(s) 652 into a position where the guest may score points. Such environmental effects may include, but are not limited to, currents 662 and whirlpools 664, which act in a selected area. For example, the currents 662 may urge the opponents' raft 632 in a selected direction that is advantageous to the guest, while the whirlpools 664 may substantially immobilize the opponents' water raft 632. In alternative embodiments, the guest may use the interactive glove 100 to further trigger water jets 666 beneath the opponent's raft 632 to combat sensors 660 mounted on the bottom of the opponents' raft 632.

As discussed above, such combat games 650 may further include a scoreboard 668 that maintains a running tally of the number of points scored by each guest and/or groups of guests. One or more top placing guests may subsequently receive selected rewards for their performance

### Treasure Hunt

As shown in FIGS. 6F and 6G, the interactive glove 100 may also be employed in a treasure hunt game. In an embodiment, the treasure hunt game comprises a container, such as a chest 670 that is “hidden” in a selected location on the water park grounds and includes a treasure 672 therein. For example, the chest 670 may be hidden at the bottom of a recreational pool. In certain embodiments, the chest 670 is advantageously configured with the sensor 104 in communication with a lock 674.

In playing the game, the guest searches the water park grounds for one or more of the chests 670. Upon discovering the chest 670, the guest may use his or her glove 100 to provide a signal that, when received by the sensor 104, opens the chest 670. Upon opening the chest 670, the guest may claim his or her treasure 672. In certain embodiments, the treasure 672 may comprise rewards.

### Play Structure

As illustrated in FIG. 6H, the interactive glove 100 can also be used with a play structure 680. In certain embodiments, the play structure 680 comprises a single or multi-level structure having a plurality of interactive play effects. The structure 680 may be suitable for outdoor or indoor use, as desired. The structure 680 further comprises a plurality of actuatable water park features in communication with a plurality of sensors 104.

Examples of such actuatable water park features may include, but are not limited to, those discussed above with respect to FIGS. 2A-2F, such as buckets 202 holding water 204 and spray jets 206, 208, 210. Exemplary play structures usable with embodiments of the invention are described in more detail in U.S. Pat. No. 5,194,048, issued Mar. 16, 1993, U.S. Pat. No. 5,865,680, issued Feb. 2, 1999, U.S. Pat. No. 7,029,400, issued Apr. 18, 2006, U.S. Pat. No. 5,378,197, issued Jan. 3, 1995, and U.S. patent application Ser. No. 11/735,222, filed Apr. 13, 2007, published as U.S. Patent Application Publication No. 2007-0249425 A1, each of which is hereby incorporated herein by reference in its entirety and is to be considered part of this specification.

In use of the play structure 680, guests may employ their gloves 100 to actuate select interactive water park features. In some embodiments, the interactive water park features may be produced immediately, while others may be delayed. Furthermore, groups of guests may employ their gloves 100 together, providing signals to a plurality of sensors 104 in order to actuate a particular feature. In general, features that require more guests to actuate may produce greater and more spectacular effects. In further embodiments, the guests may be called upon to experiment with their gloves 100 in order to determine how a selected interactive feature may be activated. Repeated play within a particular play structure 680 may be recorded and rewards issued based upon the number and/or frequency of correct usages of the glove 100 to produce desired effects.

### Guest Monitoring

The interactive glove 100 may also used as a guest monitoring mechanism. In general, water park environments are designed to be safe places for guests, particularly children. Under certain circumstances, however, a guest may find himself or herself in need of assistance. For example, a child guest may become lost or become ill and be without adult supervision. Embodiments of the glove 100 may be configured so as to signal for assistance, with or without action by the guest.

In certain embodiments, the glove 100 may be used to signal for assistance in circumstances when the guest becomes lost. The glove 100 may generate a plurality of position signals that are received by one or more sensors 104 distributed throughout the water park. In one example, the signal may comprise a GPS signal that provides coordinates of the position of the glove 100. In alternative embodiments, the position of the glove 100 may be triangulated based upon the strength of the position signal received by various sensors 104. A position tracking system may then receive and record the guest's position information.

In one embodiment, the guest may activate their glove 100 to broadcast a signal indicating that they are in need of assistance. Upon receipt of the request for assistance by one of the sensors 104, notice may be provided to a monitoring station. Personnel staffing the monitoring station may then be dispatched to the guest's location to provide assistance.

In another embodiment, a request for assistance may be issued automatically by the position tracking system based on the recorded position of the guest. For example, should the guest's position remain substantially stationary for a selected length of time, the position tracking system may issue a request for assistance. The implication under this circumstance is that if the guest is stationary for greater than the selected length of time, the guest may be injured and/or unconscious and in need of assistance. In another example, the position tracking system may issue a request for assistance if the guest enters a location that is designated as “off limits.” The implication under this circumstance is that a guest entering an off-limits area is lost and in need of assistance.

In a further embodiment, the glove 100 may be used to request assistance in circumstances when the guest is physiologically distressed. As discussed above, embodiments of the glove 100 may be configured so as to measure a plurality of selected physiological parameters of the guest, such as pulse rate. The glove 100 may record the guest's pulse rate and, when the pulse rate exceeds a selected threshold for a selected duration, the glove 100 may generate a wireless signal indicating that assistance is required. Upon receipt of the signal by one or more adjacent sensors 104, the position monitoring system may issue a request for assistance, which may further include position tracking information as discussed above for identifying the location of the guest. In this manner, the guest may receive potentially necessary medical treatment in a timely manner.

### Home Use

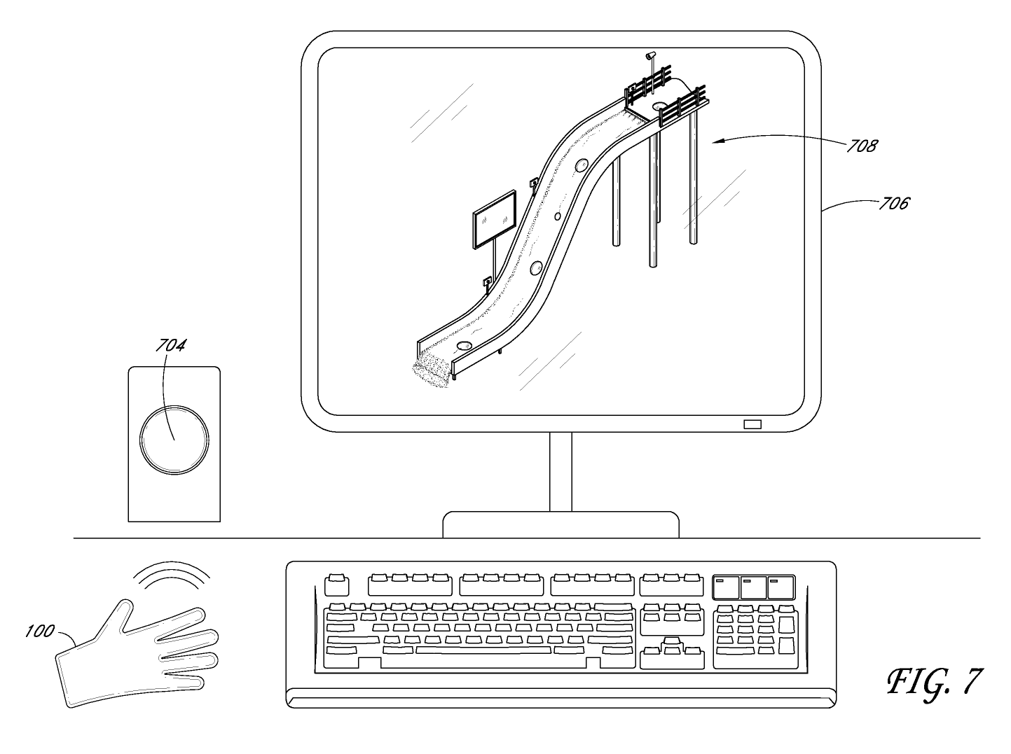

In certain embodiments, the interactive glove 100 may also be used in a home environment to enhance a user's water park experience. For instance, FIG. 7 illustrates a home sensor 704 configured for communication with a home computer 706 using signals generated by the glove 100. Appropriate software can also be installed on the computer 706 that facilitates the guest's home use of the glove 100 and home sensor 704.

In one embodiment, the home sensor 704 may be used to enhance the guest's confidence in using the interactive glove 100. For example, the software may provide tutorials that allow the guest to practice generation of signals, such as gestures or wireless signals, using the glove 100. If the signals are recognized by the sensor 704, the computer 706 may display a corresponding effect or indicate that the signal was correct. The software may further coach the guest in proper signaling using the glove 100 should they have difficulty with generating one or more selected signals. In this manner, the guest may develop and refine their proficiency with the interactive glove 100 when not attending a water park.

In another embodiment, the home sensor 704 may be used to play a virtual water park game. For example, the game may provide a representation of at least a portion of a selected water park that. is displayed on the computer 706. In the game, the guest may “walk” through the water park to encounter virtual actuatable features 708 that may be activated in the same manner that they would employ in the water park. This may allow the guest to become familiar with selected water parks so that he or she is able to take full advantage of the interactive capabilities of glove 100 when attending the water park.

In a further embodiment, the guest may use the glove 100 to enhance his or her online experience with a water park website. In one example, the guest may use a selected signal to logon the water park website. In another example, selected signals provided by the interactive glove 100 to the sensor 704 may unlock access to “secret areas” of the water park website. These secret areas may include content not otherwise accessible on the water park website.

The use of the glove 100 when visiting the water park website may further be recorded by the website and used as a basis for rewards. For example, the guest may receive rewards if he or she uses the glove to logon to the water park website with a selected frequency, such as once a day for a week.

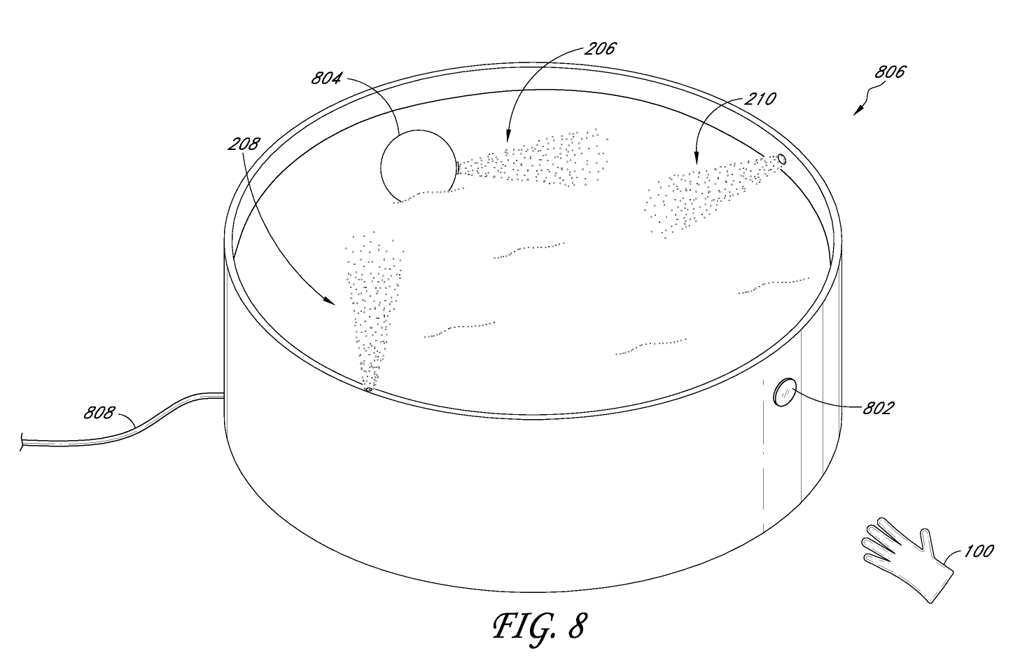

In further embodiments, the interactive glove 100 may also be used in the guest's home in order to enhance water play experiences. For instance, embodiments of the invention may comprise self-contained water play systems or other like retail devices that may be purchased by a consumer. As illustrated in FIG. 8, one or more home sensors 802 may be configured for communication with a plurality of water toys 804 and/or water spaces 806 that provide a plurality of actuatable features such as water jets 206, 208, 210. The sensor(s) 802 may be incorporated into the water toys 804 and spaces 806 or provided separately from the toys 804 and spaces 806. The toys 804 and spaces 806 may be further configured with water reservoirs or in communication with a water source, such as a hose 808, so as to provide water for the water effects.

Examples of such water toys 804 and water spaces 806 may include, but are not limited to, pool noodles, floatation devices, inflatable balls and rafts, natural pools, man-made above-ground and in-ground pools, water slides, slip-and-slides, combinations of the same and the like. Using signals generated by the glove 100, the guest activates one or more of the actuatable features of the toys 804 and/or water spaces 806, to generate a plurality of the water effects, just as they would in a water park environment. So configured, the home water play experience of the guest may be enhanced by use of the interactive glove 100.

In yet other embodiments, the glove 100 may be used with a variety of interactive play systems or modules that are situated in different locations. In such embodiments, for instance, the glove 100 can be configured to store information regarding the progress of the participant during a particular interactive game. This information can then be used to affect the user's experience in subsequent interactive games at the same and/or a different location. In yet other embodiments, the glove 100 can incorporate sensing, communication, and/or identification technology and/or play effects disclosed in U.S. patent application Ser. No. 10/397,054, filed Mar. 25, 2003, which is hereby incorporated herein by reference in its entirety to be considered part of this specification.

Moreover, it will be understood from the disclosure herein that feature(s) disclosed with respect to certain embodiments of the invention can be used and/or incorporated with other embodiments of the invention. For example, a features described and illustrated with respect to an embodiment illustrated in a particular drawing can be used with a second embodiment of the invention described and illustrated with respect to a second drawing.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure.

What is claimed is:

1. A system for providing water play entertainment to one or more play participants, the system comprising:
a body of water;
at least one sensor;
a glove configured to be worn by a play participant, the glove further configured to transmit a first wireless signal;
an actuatable device in communication with the at least one sensor, the actuatable device configured to cause one or more water play effects with respect to the body of water, wherein at least one of the actuatable device and the at least one sensor is disposed in, on, or around the body of water; and
a database in communication with the at least one sensor, wherein the database includes at least one association between an identity of a user of the glove and at least one of the first wireless signal, the at least one sensor, and the one or more water play effects,
and wherein, in response to the at least one sensor receiving the first wireless signal from the glove, the actuatable device performs a selected one of the one or more water play effects in accordance with the at least one association stored in the database.

2. The system of claim 1, wherein the glove further comprises one or more motion sensors for detecting motion of the glove.

3. The system of claim 2, wherein the glove is further configured to transmit the first wireless signal in response to a first motion of the glove, and wherein the glove is further configured to transmit a second wireless signal in response to a second motion of the glove, wherein the first wireless signal is different than the second wireless signal and the first motion is different than the second motion.

4. The system of claim 3, wherein the actuatable device is configured to cause the one or more water play effects with respect to the body of water in response to the at least one sensor receiving the first wireless signal, and wherein the actuatable device is configured to cause one or more second water play effects with respect to the body of water in response to the at least one sensor receiving the second wireless signal.

5. The system of claim 1, wherein the glove is further configured to produce at least one sensory effect in response to reception of a second wireless signal from the at least one sensor.

6. The system of claim 1, wherein the at least one sensor comprises a sensor configured to detect a plurality of different motions of the glove.

7. The system of claim 1, wherein the first wireless signal comprises a radio frequency signal.

8. The system of claim 1, further comprising:
a touch sensor; and
a second actuatable device in communication with the touch sensor, the second actuatable device configured to generate a second play effect in response to contact between the glove and the touch sensor.

9. The system of claim 1, wherein the play participant comprises a first play participant, and the system further comprises a second glove configured to be worn by at least one of the first play participant and a second play participant, the second glove further configured to transmit a second wireless signal.

10. The system of claim 9, wherein the first wireless signal comprises first identifier information indentifying the first play participant and the second wireless signal comprises second identifier information indentifying the second play participant.

11. The system of claim 10, wherein the actuatable device is configured to perform a second play effect in response to the at least one sensor receiving both the first wireless signal and the second wireless signal within a particular time.

12. A method of providing interactive game play within a water play environment, the method comprising:
providing handwear configured to transmit at least one wireless signal in response to activation of the handwear by a play participant during an interactive game;
providing a plurality of sensors, each of the plurality of sensors configured to receive the at least one wireless signal from the handwear when the handwear is within a particular distance thereof;
providing a plurality of electronically actuatable devices in communication with the plurality of sensors, wherein at least one of the plurality of electronically actuatable devices is disposed in, on, or around a body of water, and wherein the at least one electronically actuatable device is configured to provide a water play effect;
providing a database storing at least one association between the handwear and at least one of the at least one wireless signal, at least one of the plurality of sensors, and at least one of a plurality of play effects associated with the plurality of electronically actuatable devices; and
providing a control module in communication with the database, the plurality of sensors and the plurality of electronically actuatable devices, the control module being configured to, based at least on the at least one association in the database, selectively instruct one or more of the plurality of electronically actuatable devices to provide one or more of the plurality of play effects in response to one or more of the plurality of sensors receiving the at least one wireless signal from the handwear.

13. The method of claim 12, further comprising recording in the database an occurrence of the one or more of the plurality of play effects in response to the one or more of the plurality of sensors receiving the at least one wireless signal from the handwear.

14. The method of claim 13, further comprising updating, based at least on the occurrence, the at least one association in the database to comprise an updated association between the handwear and a second play effect of the plurality of play effects.

15. The method of claim 12, wherein the handwear comprises a waterproof glove.

16. The method of claim 12, further comprising recording in the database information indicative of a progress of the play participant in the interactive game.

17. The method of claim 16, wherein the progress corresponds to a number of the plurality of electronically actuatable devices activated by the play participant.

18. The method of claim 12, further comprising providing a handwear accessory that enables the handwear to transmit at least a second wireless signal to the plurality of sensors, wherein the handwear is not capable of transmitting the second wireless signal in the absence of the handwear accessory.

19. A system for providing interactive game play within a water play environment, the system comprising:
handwear means for transmitting at least one wireless signal in response to activation of said handwear means by a play participant during an interactive game;
means for receiving the at least one wireless signal from said handwear means when said handwear means is within a particular distance thereof;
means for actuating a plurality of play effects including at least one water play effect, said actuating means being in communication with said receiving means and being disposed in, on, or around a body of water;
means for storing an association between said handwear means and at least one of the at least one wireless signal, said receiving means, and at least one of the plurality of play effects; and
means for instructing, based at least on the association, one or more of said means for actuating to trigger one or more of the plurality of play effects in response to one or more of said receiving means receiving the at least one wireless signal from said handwear means.

20. The system of claim 19, wherein said receiving means comprises a radio frequency transceiver.
